(19) United States
(12) Patent Application Publication
(10) Pub. No.: US 2026/0206717 A1
(43) Pub. Date: Jul. 23, 2026

(54) ANIMAL WASTE RETREIVAL DEVICE

(71) Applicants: Mark William Dennis, Edmonton (CA); Darren Bradley Boone, Edmonton (CA)

(72) Inventors: Mark William Dennis, Edmonton (CA); Darren Bradley Boone, Edmonton (CA)

(21) Appl. No.: 19/033,467

(22) Filed: Jan. 21, 2025

(51) Int. Cl. A01K 1/01; A47L 5/36

(52) U.S. Cl. CPC A01K 1/01; A47L 5/36

(57) ABSTRACT

An animal waste retrieval device that is configured to provide removal of solid waste material from yards and other areas. The device includes a frame having strap members operable to facilitate securing of the animal waste retrieval device to a back and shoulders of a user. A motor is present having an intake hose member operably coupled thereto wherein the motor provides a vacuum within the intake hose member. The intake hose member is operably coupled to a container configured to receive and store solid waste material. The container has an upper portion and lower portion releasably secured together. Releasably secured in the lower portion is a bottom member wherein the bottom member creates a void underneath. The void has a multitude of lining member stored therein. The lining members are journaled through an aperture in the center of the bottom member.

### FIELD OF THE INVENTION

The present invention relates generally to animal waste removal, more specifically but not by way of limitation, an animal waste retrieval device that utilizes a combustion engine to operate a vacuum wherein waste material is introduced into a intake nozzle and directed into a container having a compostable liner.

### BACKGROUND

Maintaining a clean and sanitary environment is essential for both human health and the well-being of animals. One crucial aspect of yard maintenance that is often overlooked is the proper management and disposal of animal waste. Whether the animals in question are pets such as dogs and cats, or livestock like horses and cows, cleaning up animal waste from yards is an important practice with a wide array of benefits. These range from promoting health and hygiene to preserving the environment and fostering responsible pet ownership. One of the most compelling reasons for cleaning up animal waste from yards is the protection of public health. Animal waste, especially that of dogs, contains bacteria, parasites, and pathogens that can pose significant risks to humans and other animals. For example, feces can carry harmful organisms such as E. coli, Salmonella, and roundworms, which can lead to serious infections or diseases if they come into contact with humans or are ingested by children or other pets. Proper waste removal reduces the risk of these illnesses by limiting exposure to potentially dangerous microorganisms. In particular, young children, elderly people, and individuals with compromised immune systems are at higher risk of infection, making it even more important to keep yards free of animal waste. Moreover, waste that is left unchecked can contaminate water supplies through runoff during rain, contributing to the spread of diseases and pollution in nearby rivers, lakes, and streams.

Another reason for regularly cleaning up animal waste from yards is to safeguard the environment. Animal waste contains high levels of nitrogen and phosphorus, which can run off into the soil and water systems, leading to environmental degradation. When animal waste is left on the ground, rainwater can wash these harmful chemicals into storm drains and waterways, causing nutrient pollution. This phenomenon, known as eutrophication, can lead to algal blooms, fish kills, and the degradation of water quality in local ecosystems. Additionally, animal waste contributes to soil pollution, potentially altering the pH balance and damaging plants and other vegetation. By properly disposing of animal waste, homeowners can reduce the impact of these pollutants, promoting healthier soil, water, and wildlife. Effective waste management practices, such as composting or bagging waste for disposal, help to mitigate these negative environmental effects. Beyond the health and environmental concerns, the appearance and overall cleanliness of a yard can be significantly improved by regularly removing animal waste. A yard littered with feces not only looks unkempt but can also emit unpleasant odors. This can make outdoor activities such as gardening, playing, or simply relaxing in the yard less enjoyable for homeowners and their guests. Furthermore, neglecting to clean up animal waste can attract pests such as flies, rodents, and other scavengers. These pests may carry diseases, making the situation even more problematic. By regularly cleaning up animal waste, homeowners can maintain a pleasant, pest-free environment that is safer and more enjoyable for everyone. Cleaning up after animals is also a fundamental aspect of responsible pet ownership. When pet owners fail to manage animal waste properly, they are not only creating health and environmental risks but are also disrespecting their neighbors and community. Dog owners, for example, have a responsibility to ensure their pets do not leave waste on public property or in shared spaces such as parks and sidewalks. By taking the time to clean up after animals, pet owners contribute to a culture of respect and responsibility. This practice is especially important in urban and suburban areas where communal spaces and close living quarters make waste management an essential part of maintaining harmony among neighbors. In fact, many communities have ordinances or guidelines that require the removal of animal waste, underscoring the importance of this practice in fostering a clean and livable environment for all.

Accordingly, there is a need for a device that provides improved and efficient retrieval and removal of animal waste from yards and other areas.

### SUMMARY OF THE INVENTION

It is the object of the present invention to provide an animal waste retrieval device configured to be worn on the back of a user wherein the present invention includes a combustion engine.

Another object of the present invention is to provide a device configured to remove solid animal waste from yards and other areas wherein the present invention includes an intake member.

A further object of the present invention is to provide an animal waste retrieval device configured to be worn on the back of a user wherein the combustion engine provides operation of a vacuum member.

Yet a further object of the present invention is to provide a device configured to remove solid animal waste from yards and other areas wherein the present invention includes an container operably coupled to the intake member.

Still another object of the present invention is to provide an animal waste retrieval device configured to be worn on the back of a user wherein the container has a screen member proximate thereto in the vacuum passage configured to direct solid material into the container.

An additional object of the present invention is to provide a device configured to remove solid animal waste from yards and other areas wherein the container further includes a compostable liner.

Yet a further object of the present invention is to provide an animal waste retrieval device configured to be worn on the back of a user wherein the container is mounted to the frame member.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top view of the container of the present invention; and

FIG. 2 is a top perspective view of the container of the present invention with liner being pulled thereinto;

FIG. 3 is a rear view of the frame support of the present invention; and

FIG. 4 is a perspective view of the present invention; and

FIG. 5 is a side view of the present invention.

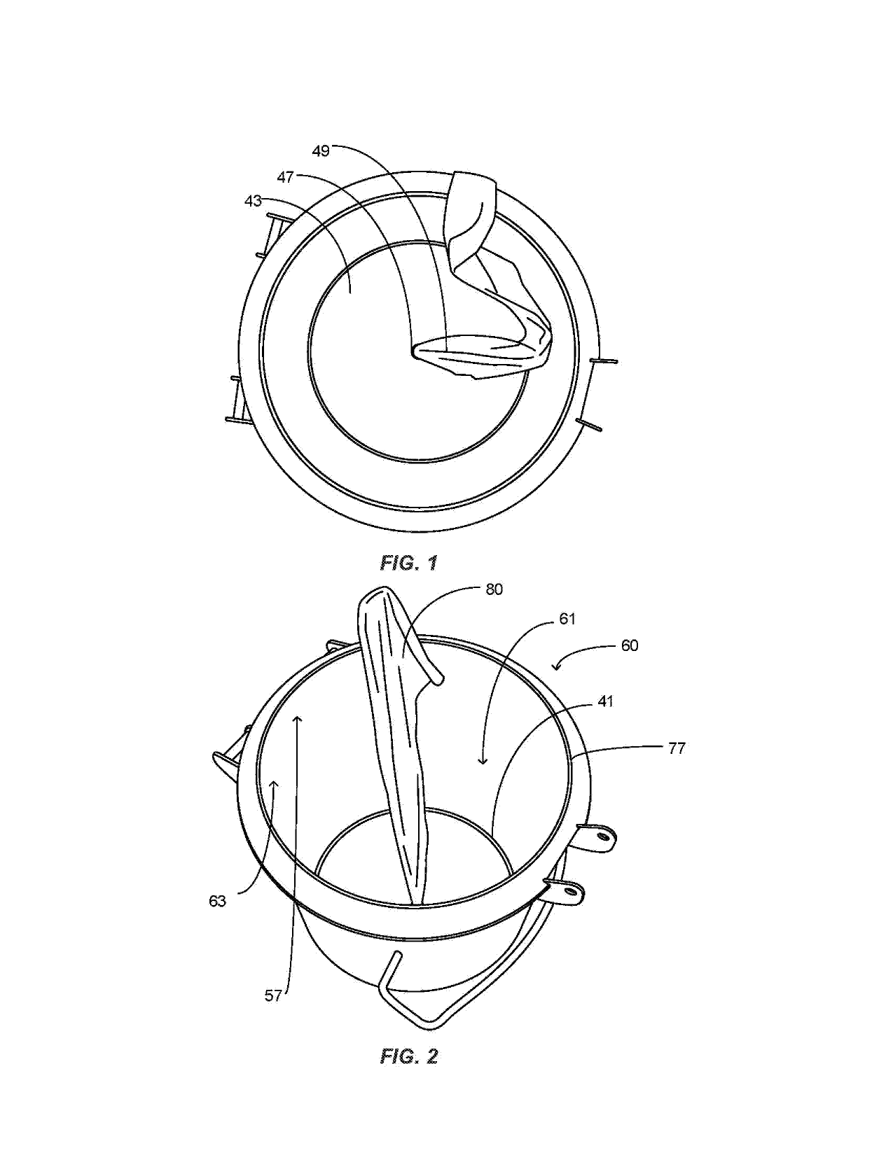

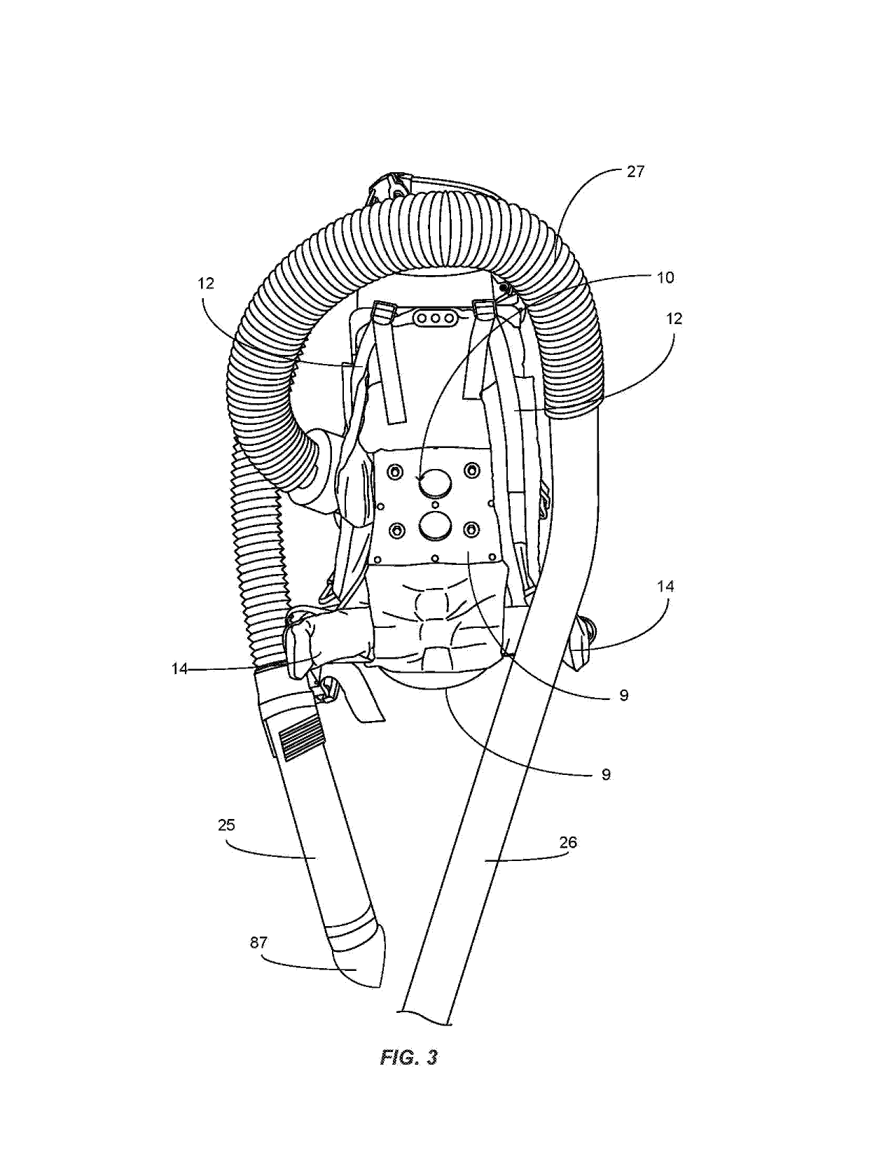

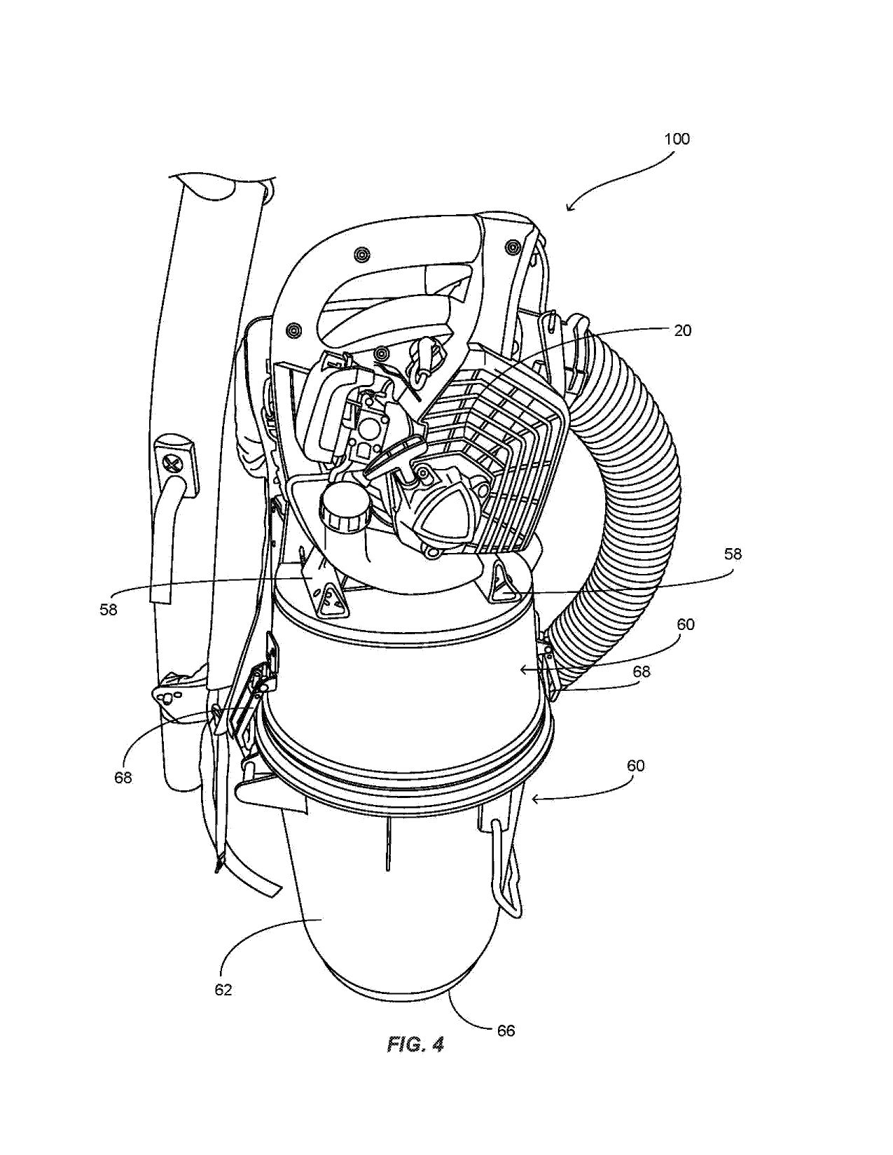

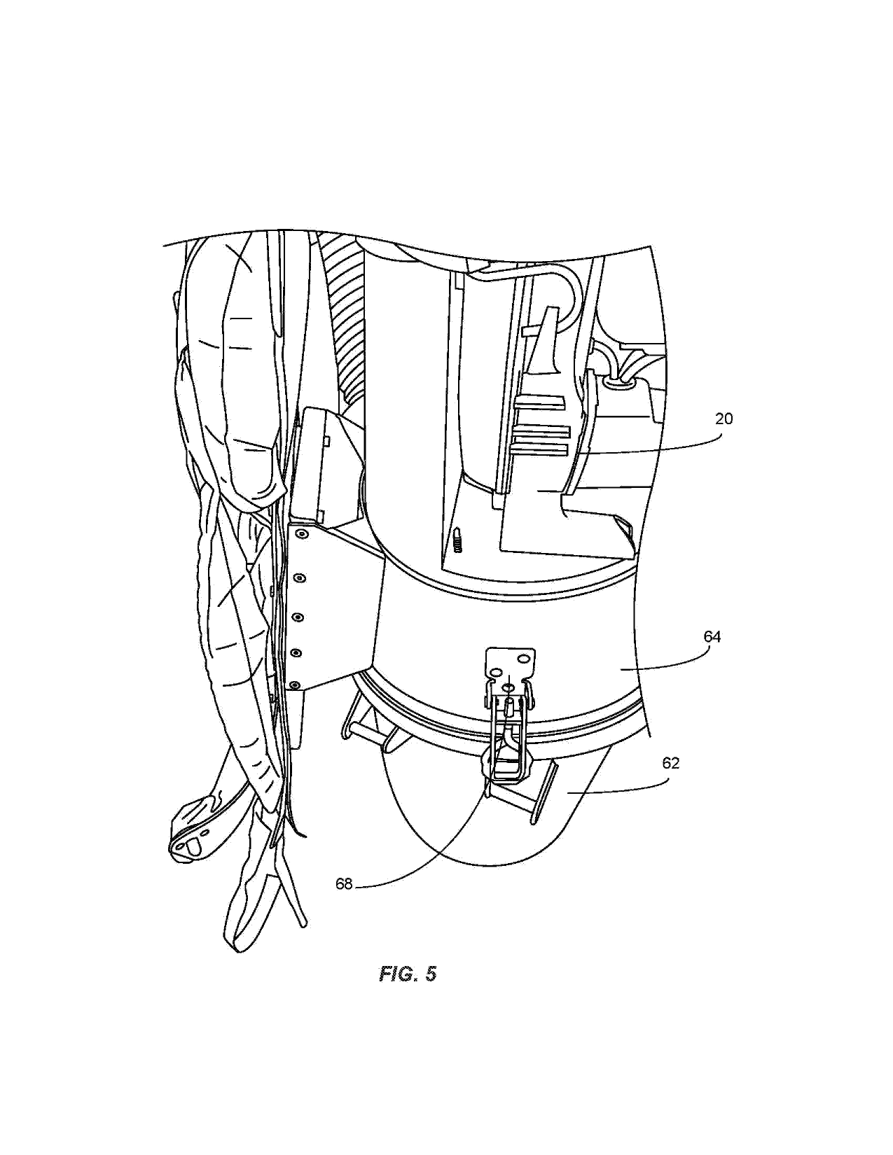

### DETAILED DESCRIPTION

Referring now to the drawings submitted herewith, wherein various elements depicted therein are not necessarily drawn to scale and wherein through the views and figures like elements are referenced with identical reference numerals, there is illustrated an animal waste retrieval device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the animal waste retrieval device 100 is configured to be worn on the back of a user and is operable to retrieve and deposit animal waste in the storage container 60 as is further discussed herein. It should be understood within the scope of the present invention that the animal waste retrieval device 100 could be manufactured in alternate sizes and employed to retrieve other items in addition to animal waste.

The animal waste retrieval device 100 includes a frame member 10 wherein the frame member 10 includes additional strap elements 12,14 that facilitate an ability for a user to secure the animal waste retrieval device 100 on their back for carrying of the animal waste retrieval device 100. Frame member 10 includes a plurality of support members 9 integrally formed to create a suitable rigid frame member 10 to be secured to a back of a user. The animal waste retrieval device 100 includes motor 20 wherein the motor 20 in a preferred embodiment of the present invention is a combustible engine motor. It should be understood within the scope of the present invention that an electrically powered motor could be utilized. Motor 20 is mounted to the upper portion 64 of the container 60 utilizing mounting members 58 wherein the mounting members 58 are secured utilizing suitable mechanical fasteners. The motor 20 provides the vacuum to provide the intake hose member 25 with sufficient vacuum to facilitate retrieval of solid waste such as but not limited to animal feces. The intake hose member 25 includes a first section 26 and second section 27 wherein the first section 26 is rigid and the second section 27 is flexible so as to facilitate the ability to manipulate the first section 26 to a desired position or location. It should be understood within the scope of the present invention that the intake hose member 25 could be provided in alternate diameters and lengths as required for the desired application. Secured to the end of intake hose member 25 is cutting member 87. The cutting member 87 extends beyond the end and is configured to provide breaking up of solid material prior to be introduced into the intake hose member 25. The cutting member 87 is manufactured from a rigid material such as but not limited to metal.

The intake hose member 25 is operably coupled to container 60. Container 60 includes a lower portion 62 and upper portion 64. Upper portion 64 is releasably secured to the lower portion 62 utilizing fasteners 68. It should be understood within the scope of the present invention that the fasteners 68 could be various alternate mechanical clamping fasteners that provide a securing of the upper portion 64 to the lower portion 62. The container 60 includes interior volume 61 having opening 63 providing access thereto. The interior volume 61 of the lower portion 62 includes a removable bottom member 43. The interior volume 61 is formed from the integrally formed wall 77 and bottom 66. Bottom member 43 is sealably secured on ledge member 41 and is suspendedly mounted above the bottom 66 of the lower portion 62. Ledge member 41 is integrally formed with the interior surface of the wall 77 and extends inward into the interior volume 61. The aforementioned mounting of the bottom member 43 on the ledge member 41 creates a void(not illustrated herein) between the bottom 66 and bottom member 43. The void provides a sufficient space to store a plurality of lining members 49. Lining members 49 are journaled through the aperture 47 present in the center of the bottom member 43. The lining members 49 are configured to have a multitude thereof operably coupled with perforation so as to facilitate removal of a lining member 49 from an adjacent lining member 49. The lining members 49 are configured to expand and provide lining of the interior wall 57 and bottom member 43 in order to receive material being deposited into the container 60 then subsequently removed upon substantial filling thereof. In a preferred embodiment of the present invention, the lining member 49 is manufactured from a compostable material.

While not particularly illustrated herein, the present invention employs a screen member within the intake hose member 25, specifically at the end thereof proximate the motor 20 and upper portion 64. The screen member functions to catch solid waste passing through the intake hose member 25 traversing towards exhaust outlet wherein the screen member facilitates the falling of the solid waste into the container 60 as travel thereof out the exhaust outlet is inhibited. It is contemplated within the scope of the present invention that the solid waste received within the intake hose member 25 could be diverted into the container 60 utilizing various alternate elements and/or techniques.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An animal waste retrieval device configured to remove solid animal waste and provide collection thereof for disposal wherein the animal waste retrieval device comprises:
a frame, said frame having a plurality of support members, said frame having strap elements configured to facilitate securing of said frame to a back of a user;
a container, said container being operably coupled to said frame, said container having a lower portion and an upper portion, said lower portion having a bottom and a wall forming an interior volume, said upper portion being releasably secured to said lower portion, said lower portion having a ledge member circumferentially disposed on an interior surface of said wall proximate said bottom, said ledge member extending inward towards said interior volume, said ledge member having releasably secured thereto a bottom member, said bottom member and said bottom having a void therebetween, said bottom member having an aperture proximate a center thereof;
a motor, said motor being mounted to said upper portion of said container being superposed thereto, said motor having operably coupled thereto an intake hose member, said intake hose member being operably coupled with the interior volume of said container; and
wherein said motor provides a vacuum within the intake hose member so as to facilitate retrieval of animal waste and deposit into said interior volume of the container.

2. The animal waste retrieval device configured to remove solid animal waste and provide collection thereof for disposal as recited in claim 1, and further including a multitude of lining members, said multitude of lining members disposed in said void between said bottom and said bottom member.

3. The animal waste retrieval device configured to remove solid animal waste and provide collection thereof for disposal as recited in claim 2, wherein said lining members are configured to be journaled through said aperture of said bottom member.

4. The animal waste retrieval device configured to remove solid animal waste and provide collection thereof for disposal as recited in claim 3, wherein one of said multitude of lining members is configured to be expanded to fill said interior volume of said lower portion of said container.

5. The animal waste retrieval device configured to remove solid animal waste and provide collection thereof for disposal as recited in claim 4, wherein the intake hose member has a first section and a second section integrally formed, said second section being manufactured from a flexible material.

6. The animal waste retrieval device configured to remove solid animal waste and provide collection thereof for disposal as recited in claim 5, wherein said lining members are manufactured from a compostable material.

7. The animal waste retrieval device configured to remove solid animal waste and provide collection thereof for disposal as recited in claim 6, wherein the intake hose member further includes a cutting member secured to and end thereof configured to extend therepast for severing of solid material prior to introduction into the intake hose member.
